(19) United States
(12) Patent Application Publication
(10) Pub. No.: US 2007/0071853 A1
(43) Pub. Date: Mar. 29, 2007

(54) Methods and devices for preserving effervescence

(76) Inventor: Mary Martin Trautman, Atlanta, GA (US)

Correspondence Address: TROUTMAN SANDERS LLP, 600 PEACHTREE STREET , NE, ATLANTA, GA, 30308, US

(21) Appl. No.: 11/529,031

(22) Filed: Sep. 28, 2006

Related U.S. Application Data
(60) Provisional application No. 60/721,726, filed on Sep. 28, 2005.

(51) Int. Cl. A23B 7/148

(52) U.S. Cl. 426/106

(57) ABSTRACT

The present invention comprises methods and devices for preserving the carbonation or effervescence of effervescent beverages. In general, the methods comprise providing a device comprising a metallic shaft portion and an arm portion to an open beverage container containing an effervescent beverage. The devices may be made of metals or alloys and may be solid, hollow or plated materials, and may include nonmetal features. While the device is in place and the container is open to atmospheric air, the effervescence of the liquid is maintained for longer periods of time than are the same liquids in the similar conditions without the device present.

### CROSS REFERENCE TO RELATED PATENT APPLICATIONS

The present application claims the priority of U.S. Provisional Patent Application No. 60/721,726, filed Sep. 28, 2005, which is herein incorporated in its entirety.

### TECHNICAL FIELD

The present invention comprises methods and devices for preserving effervescence of carbonated or sparkling drinks.

### BACKGROUND OF THE INVENTION

Millions of people throughout the world drink carbonated or effervescent drinks, such as sodas, seltzers, sparkling wines and champagne. Numerous types of sparkling waters and champagne are produced and sold in many countries throughout the world. Most sparkling waters and champagne are distributed to consumers in bottles, and the bottles are usually sealed with a cork, plastic plug or cork, or other type of impervious stopper to prevent exposure to the air and to preserve the sparkling water or champagne.

Consumers of the sparkling water, carbonated beverages or champagne may drink an entire bottle, a significant portion of a bottle or only one glass, leaving a significant portion remaining in the bottle for another time. Some consumers may drink a glass or more a day. Once a bottle is opened, the seal formed between the bottle and the stopper is broken, air enters the bottle, carbonated gas within the bottle exits and the quality of the liquid remaining in the bottle may begin to degrade due to oxidation.

Many different devices have been made to inhibit the changes that occur after the initial opening of the bottle. For inexpensive carbonated beverages, the attempts are minimal, such as replacing a screwcap lid or providing a stopper, or providing the liquid in single serving amounts. For more expensive effervescent liquids, such as sparkling wines or champagnes, more elaborate systems have been designed.

Attempts to maintain the quality of the beverage once the container has been opened have included elaborate pumping systems to reduce air within the bottle to reduce the oxidation and degradation of the beverage to limit or eliminate the presence of oxygen. Simple procedures such as tightly replacing the cork and reducing the amount of air space or head space above the liquid level of the beverage in the bottle are marginally effective at limiting the degradation, but this approach does not work well for champagne or highly carbonated beverages. There are devices that are designed to evacuate the air above a beverage by using a pump to manually evacuate the air and slow the degradation of the beverage after the bottle is opened. Pumping the air from a container with an effervescent beverage would remove the carbonation from the effervescent beverage. Other known bottle vacuum devices combine vacuum pumps with a dispenser, which enables the drinker or server to leave the stopper in place until the bottle is completed, again creating a flat drink, not a bubbly drink.

Other drink preservation and dispensing devices use an inert gas to blanket the head space in a bottle. These systems use an inert gas such as nitrogen from a large gas storage cylinder or smaller portable containers. Several types of such nitrogen preservation systems are known. Some systems preserve only one wine bottle and others preserve a plurality of wine bottles. Attaching a system to pump gas into the head space of one or more bottles is a manually operated, mechanical and imprecise procedure for most consumers. With more drinking, more head space is created which requires more gas, and people attempting to judge whether they have added enough are likely to add too little, leaving air in the bottle, or add too much, and unduly stress the stopper, the bottle and the pumping mechanism. In short, these devices may be adequate for professional operations with highly skilled operators, but even then require training, do not consistently and reliably maintain effervescence, do not provide positive pressure systems, require a separate gas blanket and stopper for each open bottle, and require undesired manual operation by the wine drinker or server. Thus, trying to replace the head space in a bottle is logistically difficult. People enjoying a glass of champagne or sparkling water typically do not want to contend with such detailed or specific procedures.

Systems that utilize large gas cylinders provide a plentiful supply of inert gas; however, the cylinders are large and, therefore, hard to obtain, store or transport. A large gas cylinder is unattractive and too bulky to store in a kitchen or other convenient location in a home. The small portable gas canisters and cartridges are small enough to store under a sink or cabinet. However, these systems are limited because a canister or cartridge may only be used a limited number of times before running out of inert gas. Therefore, a user must store or transport several canisters or cartridges when using this type of system. Also, the canisters and cartridges must be replaced, which can be time consuming and expensive. Nitrogen is preferably used because nitrogen is an inert, non-flammable gas though other inert gases, such as argon could be used in place of nitrogen. Argon, in particular, is understood to be one of the best blanketing gases because it is a heavy gas (approximately 1.4 times heavier than nitrogen) and tends to pool over a target area. Argon, however, makes up less than one percent of air and is therefore generally too limited and expensive to be used for such purposes.

Accordingly, a need exists for a reliable, safe and efficient sparkling water, effervescent beverage and champagne preservation devices and methods that are simple to use, that can be easily transported and does not significantly impede the dispensing of the beverage.

### DESCRIPTION OF FIGURES

FIG. 1 shows exemplary effervescent maintenance devices of the present invention that resemble botanical items.

### DETAILED DESCRIPTION

The present invention comprises methods and devices for preserving effervescent beverages in open containers or maintaining the effervescence of beverages for a period of time after the initial removal of the original stopper from the beverage container. Without the presence of the devices or articles of the present invention, the effervescent beverages would go flat, or lose the bubbles or carbonation, or release a large percentage of the carbon dioxide that had been present in the beverage prior to opening. With a device of the present invention in place, an effervescent beverage will maintain higher carbon dioxide levels and retain its pleasant bubbly taste much longer than an open bottle of effervescent beverage without the device.

As used herein, an effervescent beverage includes any liquid that either naturally or through any means, such as through fermentation, or by addition of fermentation means to produce additional carbon dioxide within a liquid, or other means to produce carbon dioxide within a liquid, or by direct addition of carbon dioxide to a liquid, contains carbon dioxide or any other gas that provides bubbles to the liquid. For example, an effervescent beverage releases carbon dioxide under conditions of normal atmospheric pressure, which generally occurs upon opening of the container of the beverage. Carbonation may occur naturally in spring water that has absorbed carbon dioxide at high pressures underground. It can also be a byproduct of fermentation such as beer and some wines, such as sparkling wines, champagne, Sekt, Vin mousseux, Vino spumante and any kind of wine containing a visible excess of carbon dioxide, “crackling wines” in the United States of America, “vin petillant” in France, or “Perlweine” in Germany. Seltzer water and club sodas are examples of artificially carbonated waters, which may or may not contain other ingredients. Carbonated beverages, including colas, noncolas, and a myriad of other types, are available and are included in the present invention. These effervescent beverages and others are contemplated by the present invention.

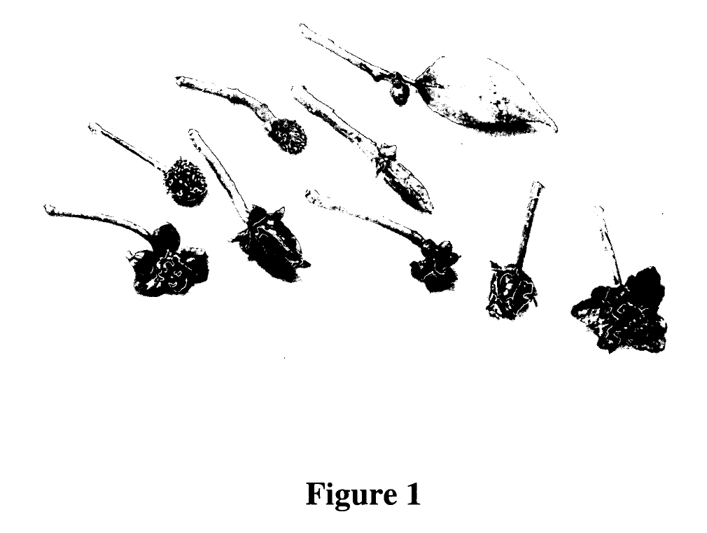

As used herein the terms articles, effervescent maintenance devices, and devices are used interchangeably. The devices of the present invention comprise metallic articles comprising a shaft portion and an arm portion. The shaft portion is generally rod shaped, and may be straight or curved, and generally is of a diameter that can be inserted into a beverage container. The shaft comprises a distal end that is inserted first into the beverage container and a proximal end that is attached to, adjacent to or contiguous with the arm portion. The diameter may be from about 0.2 mm to about 100 mm. The device may be of a length of from about 2.0 mm to about 1000 mm and may include the arm length. For example, the shaft portion may be contiguous with the arm portion and thus the length may be longer in a device where there is not a clear demarcation between the arm portion and shaft portion. FIG. 1 shows examples of devices having a shaft and arm portion, and such devices resemble botanical items. For example, exemplary devices may have shafts that may be from 1 inch to 5 inches.

The arm portion of the device may function to keep the device from completely entering the beverage container. Alternatively, the shape of the device, such as an arcing curve may function to hold the device in place in the entry of the container and prevent the device from completely entering the container. The present invention comprises providing devices in the opening of a container so that a portion of the device is retained near the entrance of the container so that air flow into or out of the container crosses the device. In one aspect of the invention, the device does not touch the liquid within the container.

The arm portion of the device may take any shape. In one method, it is desirable that the distal end of the shaft, that is the end farthest from the arm portion of the device not touch the bottom of the beverage container, or not touch the liquid within the container. Thus, the arm portion may be of any shape necessary to retain the device within the upper portion of the beverage container. For example, in any method, the arm portion may be a bar, a hook, a T shape, a J, a clip that attaches to the lip of the beverage container, a chain, a loop, or any shape that functions to anchor the shaft portion in a position in the beverage container. It is contemplated that the arm remain outside the bottle. In one aspect, the effervescent maintenance device comprises a shaft that is substantially straight, and an arm that is a disc, such that the shaft enters the effervescent liquid container, and the disc remains exterior to the container. The disc may be used to engrave lettering or pictures upon it. The disc can be in any shape.

The device may be made to resemble a botanical plant, including, but not limited to, a flower and stem or a leaf and stem, or a twig, or a bunch of fruit or berries on a branch. In such a device, the arm portion of the device may be shaped like a flower, a leaf, a bud, branches, a bunch of berries or fruits, etc. The shaft portion is shaped like a stem, twig, vine, or other botanical support structure.

The device may serve other functions. For example, the device may be worn as an earring or a piece of jewelry, and once the effervescent beverage is opened, the device is removed from the body and placed in the beverage container to maintain the effervescence of the liquid. In this way, the devices are always available and easily at hand.

The device may be made of any metal. The metal may be flexible or rigid. For example, the devices may be made of flexible wire that can be formed into a shaft portion and an arm portion so that the shaft portion extends into the beverage container and the arm portion extends outward of the beverage container to anchor the shaft portion. The metal may be any known metal or may be a combination of metals or alloys, including but not limited to, silver, sterling silver, gold, platinum, zinc, copper, nickel, iron, aluminum, molybdenum, lead, brass, titanium or steel, stainless steel. The devices may be of a solid or hollow material, metal or alloy or may be plated metals, having one metal plated on another metal.

In one aspect, the shaft of the article is made of one or more metals or an alloy, or plated metals, and the arm may be made of the same or different material. The arm may comprise one or more nonmetals of any type including, but not limited to, gem stones, ceramic, porcelain, wood, enamel and enameled portions.

Containers of beverages as used herein comprise any container in which effervescent beverages may be provided including, but not limited to, plastic bottles, glass bottles, aluminum cans, glasses, flutes, champagne glasses, sherberts, water glasses, kegs, steins, and wine glasses. For example, the devices of the present invention may be provided to the throat of an opened glass champagne bottle wherein the distal end of the shaft is inserted in the opening of the bottle and the arm of the device remains exterior to the bottle opening. For example, in a champagne flute (glass), a small J-shaped device of the present invention is placed so that the arm hooks over the rim of the flute and the shaft portion enters the flute.

The methods of the present invention comprise adding the devices taught herein to open containers of effervescent beverages. Methods of the present invention comprise a method for retaining effervescence of an effervescent liquid, comprising, adding a metallic article comprising a shaft portion and an arm portion to an open effervescent beverage container containing an effervescent beverage, wherein the metallic article is partially retained within the beverage container. For example, a method comprises, adding, to an open container of an effervescent beverage in which an effervescent beverage is present, a metallic device comprising a shaft portion and an arm portion, wherein the shaft portion is inserted into the beverage container and the arm portion retains the shaft portion within the beverage container. While the device is in place, some effervescence of the liquid is maintained even though the container remains open.

Methods of the present invention comprise retaining the effervescence of an effervescent liquid, while stored in an open container, generally under refrigeration, for a time period ranging from about 0 to 24 hours, for about 0 to 36 hours, for about 0 to 48 hours, 6-24 hours, for 6-36 hours, and for all time ranges in between. Methods comprise retaining effervescence of a liquid with a device of the present invention for about 6 hours, for about 12 hours, for about 36 hours and about 48 hours. At each time point, until a significant loss of carbonation occurs, the effervescence of a liquid in an open container in the presence of the device is greater than a similar liquid in an open container without the device. A method of the present invention comprises a) placing a device comprising at least a metallic shaft in the opening of a champagne beverage container. The champagne may be chilled. The method further comprises b) removing the device to pour some champagne into a glass or in the alternative, to drink some of the champagne, and replacing the device in the opening of the champagne beverage container. The method further comprises repeating step b) at a later time, and in multiple iterations until there is no more champagne. The device may then be removed, cleaned and stored.

### EXAMPLES

### Example 1

A 2 liter bottle of carbonated soda is opened and a device, shaped like capital T, made from sterling silver, was placed in the opening of the bottle. A 2 liter bottle of carbonated soda is opened and no device is inserted. The soda is tasted every 2 hours, and after 6 hours, the soda without the device is much flatter than the soda with the device.

### Example 2

A bottle of champagne is opened and a device shaped like a seed pod, flower or a leaf or multiple leaves on a stem of a tree is inserted in the neck of the bottle. The curve of the shaft holds the device in place so that the seed pod portion is above the rim of the opening and the stem is in the neck of the bottle. The device is removed and the champagne is poured. After pouring, the device is replaced and the bottle is placed on ice. Over time, more drinks are poured and the effervescence of the champagne remains pleasant and does not go flat for six to 10 hours.

### Example 3

Commercially available champagne was tested with devices of the present invention. The devices were made of sterling silver metal, and had a shaft portion that resided within the bottle of champagne and an arm portion that remained outside of the bottle. Samples were made at 0, 6, 24, 36, 48 and 60 hours and are presented in Table 1. An open bottle was used as the reference standard, and a commercial champagne stopper was a positive control. The devices tested were similar to those shown in FIG. 1, and were a solid silver device resembling a violet leaf, (shaft is stem, arm is leaf) a solid sterling silver device resembling a dogwood stem with berries attached at the end (shaft is stem, arm is berries), a solid sterling silver device resembling camellia stem and a pair of leaves, (Taylor's Perfection) (shaft is stem, leaves are the arm), and a hollow sterling silver device resembling a daylily stem and two branches, shaped like a capital Y. (shaft is stem, branches are the arm).

The following procedure, an accepted method for measuring CO₂ and H₂CO₂, was used. Reagent grade chemicals were used in all tests. Unless otherwise indicated, all reagents conform to the specifications of the Committee on Analytical Reagents of the America Chemical Society. Other grades may be used, provided it is first ascertained that the reagent is of sufficiently high purity to permit its use without lessening the accuracy of the determination.

Sampling

1 Collect the sample in accordance with the applicable ASTM methods.

2 Use a hard glass, chemically resistant bottle for collecting the sample.

3 The sample bottle was filled completely, with no air space remaining beneath the cap, and the sample may be stored at a temperature below that at which it was collected until the determination is made.

This method determined carbon dioxide CO₂ present as CO₂ and carbonic acid, H₂CO₃. Any concentration can be determined in any type of water without interference from color, turbidity, and common water contaminants.

Carbon dioxide was liberated by acidifying and heating the sample in a closed system, which includes a condenser, a gas scrubber, a CO₂ absorber, an expansion bladder, and a gas-circulating pump. The liberated CO₂ is combined with barium hydroxide in an absorber, and the excess hydroxide is titrated with standard acid. Concentrations of the several carbonate species are determined from the pH and total CO₂ values.

The basic apparatus for the determination consisted of an evolution flask, an absorption flask, and a pump connected into a closed system so that the contained air can be circulated continuously through both flasks. A small air-vacuum pump available from laboratory supply houses is satisfactory for this purpose. pH was determined with a pH Meter.

Reagents

Barium Hydroxide Solution (2.7 gBa(OH)₂/litre)—Dissolve 5.0 g of Ba—(OH)₂-8H₂O I 1 liter of freshly boiled water. Store in a bottle fitted with an automatic-zero buret, and protect the air inlet of the bottle and the vet of the buret with soda-asbestos or soda-lime tubes.

Hydrochloric Acid, Standard (0.04N)—Dilute 3.42 ml of HCl (sp gr 1.19) to 1 litre and standardize.

Methyl Orange Indicator Solution (0.5 g/litre)—Dissolve 0.05 g of methyl orange in water and dilute to 100 ml.

Phenolphthalein Indicator Solution (5 g/litre)—Dissolve 0.5 g of phenolphthalein in 100 ml of a 0.50 percent solution of ethyl alcohol in water.

Scrubbing Solution—Pour the contents of a commercially available, 25-ml vial of chromic acid (CrO₃,) slowly and cautiously into a 9-lb (4-kg) bottle of sulfuric acid (H₂SO₄, sp g 1.84) and mix. This scrubbing solution will absorb interfering substances normally present including ammonia (NH₂) and sulfur dioxide (SO₂) but not hydrogen sulfide (H₂S). The latter can be removed by a supplementary scrubber containing Iodine solutions (25 g/litre) placed between the (K₂Cr₂O₇—H₂SO₄) trap and the condenser.

Sulfuric Acid (7+993)—Add 7 ml of H₂SO₄ (sp gr 1.84) to 500 ml of water, mix and dilute to 1 litre with water.

Procedure

Blank Determination:

Acidify 400 ml of water to the methyl orange end point (approximately pH 4) with H₂SO₄ (7+993) and boil vigorously in an Erlenmeyer flask for at least 15 min to remove dissolved CO₂.

Add 0.2 ml of phenolphthalein indicator solution to the clean absorption flask, measure into it 50 ml of Ba(OH)₂ solution, and place the flask securely on the stopper, as shown in FIG. 1. Pour approximately 200 ml of the freshly boiled water into the evolution flask, and add 15 ml of H₂SO₄ (7+993) from the buret. Turn on the cooling water to the condenser, light the burner, and heat the contents of the evolution flask rapidly to boiling. When boiling begins, start air circulation with the pump, reduce the burner flame to maintain boiling, without excessive refluxing and continue boiling and air circulation for 5 min. Start and stop the pump several times in rapid succession, at the beginning of the circulation, to prevent bumping and priming while equalizing pressures, if necessary. Without shutting off either pump burner, titrate the Ba(OH)₂ in the absorption flask with 0.04N HCl from the buret. The end point of the titration must be approached slowly for accurate result or it will be either overrun or the pink color of phenolphthalein will reappear. Record the milliliters of HCl used in the titration as V₁.

Make such blank determinations before each series of CO₂ determinations until three consecutive values check within 0.1 ml of 0.04 N HCl. If the apparatus and reagents have been unused for several days, the blank determinations are particularly necessary.

Carbon Dioxide Determination:

For samples with less than 150 mg/litre of CO₂, repeat the procedure described for determining the Blank on a portion of the clear sample. Record the milliliters of HCl required as V₂.

If the CO2 content of the sample exceeds 150 mg/litre, use a proportionately smaller sample and adjust the calculations accordingly. If the CO₂ content is below 1 mg/litre, use a proportionately larger evolution flask and sample. In cases of unusual sample sizes, either the volume of air above the sample in the evolution flask must be kept the same, or the air bladder volume must be increased appropriately to prevent pressure build-up. Where extremely accurate measurement of free CO₂ is required, special sample handling techniques are necessary. A satisfactory scheme is to evacuate the generating flask and introduce the sample at reduced pressure

pH Determination—Determine the pH of the clear sample. If the temperature of the sample at the time of the test is different from its temperature at the time of collection, a different CO₂—HCO₂ equilibrium and a different pH will result. This may be partially overcome by adjusting the sample to the collection temperature and shaking it thoroughly before opening it for CO₂ and pH tests. It is best to avoid the problem by measuring pH at the time of sample collection and sealing the sample to prevent loss or gain of CO₂.

Calculations

Calculate the concentration of total CO₂, as follows:
Total CO₂, mg/litre=110 N(V₁−V₂)

where:

N=normality of HCl,

V1=milliliters of HCl required for titration of 50 ml of Ba(OH)₂ solution in the blank determination, and

V2=Milliliters of HCl required for titration of residual Ba(OH)₂ after absorption of the CO₂ evolved from the sample.

Determine the concentrations in milligrams per liter of carbonic acid, carbonate ion, and bicarbonate ion by means of computer methods, or estimate them from the curves. These curves express the respective fractions of the total CO₂ that are present as undissociated carbonic acid (H₂CO₃), bicarbonate ion (HCO₃⁻), and carbonate ion (CO₃⁻⁻) at all pH levels. Using the pH of the original sample as the abscissa, read the corresponding ordinates of the three curves and record the three values (whose sum should equal 1.0) as a, b, and c, respectively. Calculate the several acid and ion concentrations in milligrams per liter using the equations below:
(CO₃⁻⁻)=150 Na(V₁−V₂)
(HCO₃⁻)=152.5 Nb(V₁−V₂)
(H₂CO₃)=155 Nc(V₁−V₂)
This method of estimating ion concentrations is based on data for the ionization of carbonic acid at 25° C., the values obtained hold for this temperature only. At any other temperature the ion concentrations will have other values, which may be calculated if the dissociation constants of carbonic acid at this temperature are known. The values for the ion concentrations obtained in this manner are first approximations based upon the assumption that the activity coefficient of each ion is unit.

The effectiveness of the devices of the present invention, as shown by this experiment is determined by a comparison of a device to the reference standard, the open bottle, the percent difference in the CO₂% lost. At 6 hours, the commercial stopper was 13% more effective than the open bottle, the violet device was 41% more effective than the open bottle, the dogwood device was 19% more effective than the open bottle, the camellia (Taylors perfection) was 33% more effective than the open bottle, the daylily was 19% more effective than the open bottle. Thus, the present invention is effective at keeping the effervescence in an effervescent liquid. At 36 hours, the commercial stopper was 9% more effective than the open bottle, the dogwood device was 4% more effective than the open bottle, and the camellia device (Taylors perfection) was 4.2% more effective than the open bottle. The articles or devices of the present invention are more effective than an open bottle even at such a long interval of having the bottle open to the atmosphere.

TABLE 1
Measurements of Dissolved CO2 in Champagne

| No. | Sample ID | H₂CO₃ % | CO₂ % | CO₂ lost % |
|---|---|---|---|---|
| | | T = 0 hrs | | |
| 1 | Opened bottle | 0.461 | 0.327 | NA |
| 2 | Commercial stopper | 0.461 | 0.327 | NA |
| 3 | Violet leaf | 0.461 | 0.327 | NA |
| 4 | Dogwood berries | 0.461 | 0.327 | NA |
| 5 | Taylor's perfection | 0.461 | 0.327 | NA |
| 6 | Daylily Stem | 0.461 | 0.327 | NA |
| | | T = 6 hrs | | |
| 1 | Opened bottle | 0.409 | 0.290 | 11.31 |
| 2 | Commercial stopper | 0.415 | 0.295 | 9.79 |
| 3 | Violet leaf | 0.430 | 0.305 | 6.72 |
| 4 | Dogwood berries | 0.418 | 0.297 | 9.17 |
| 5 | Taylor's perfection | 0.424 | 0.302 | 7.64 |
| 6 | Daylily Stem | 0.418 | 0.297 | 9.17 |
| | | T = 24 hrs | | |
| 1 | Opened bottle | 0.394 | 0.280 | 14.37 |
| 2 | Commercial stopper | 0.400 | 0.284 | 13.15 |
| 3 | Violet leaf | 0.394 | 0.280 | 14.37 |
| 4 | Dogwood berries | 0.397 | 0.282 | 13.76 |
| 5 | Taylor's perfection | 0.381 | 0.271 | 17.13 |
| 6 | Daylily Stem | 0.394 | 0.280 | 14.37 |
| | | T = 36 hrs | | |
| 1 | Opened bottle | 0.394 | 0.280 | 14.37 |
| 2 | Commercial stopper | 0.400 | 0.284 | 13.15 |
| 3 | Violet leaf | 0.394 | 0.280 | 14.37 |
| 4 | Dogwood berries | 0.397 | 0.282 | 13.76 |
| 5 | Taylor's perfection | 0.397 | 0.282 | 13.76 |
| 6 | Daylily Stem | 0.394 | 0.280 | 14.37 |
| | | T = 60 hrs | | |
| 1 | Opened bottle | 0.368 | 0.262 | 19.88 |
| 2 | Commercial stopper | 0.370 | 0.263 | 19.51 |
| 3 | Violet leaf | 0.367 | 0.262 | 19.86 |
| 4 | Dogwood berries | 0.369 | 0.260 | 20.50 |
| 5 | Taylor's perfection | 0.369 | 0.260 | 20.50 |
| 6 | Daylily Stem | 0.380 | 0.267 | 18.35 |

What is claimed is:

1. A method for retaining effervescence of an effervescent liquid, comprising, adding a metallic article comprising a shaft portion and an arm portion to an opened container containing an effervescent liquid, wherein the metallic article is at least partially retained within the opened container.

2. The method of claim 1, wherein the effervescent liquid is sparkling water, sparkling wine, champagne, Sekt, Vin mousseux, Vino spumante, crackling wine, vin petillant, Perlweine, seltzer water, club soda, or carbonated beverage.

3. The method of claim 1, wherein the metallic article comprises silver, sterling silver, gold, platinum, zinc, copper, nickel, iron, aluminum, molybdenum, brass, titanium, steel, stainless steel, or combinations thereof.

4. The method of claim 1, wherein the arm portion further comprises gem stones, ceramic, glass, porcelain, wood, polymers, enamels, or combinations thereof.

5. The method of claim 1, wherein the metallic article is a solid article or at least partially hollow article.

6. The method of claim 1, wherein the shaft portion comprises a diameter of about 0.2 mm to about 100 mm.

7. The method of claim 1, wherein the arm portion is of a shape which prevents the metallic article from completely entering the opened container.

8. The method of claim 1, wherein the metallic article is shaped to resemble at least a portion of a botanical plant.

9. The method of claim 1, wherein the metallic article does not touch the effervescent liquid within the opened container.

10. The method of claim 1, wherein the effervescence of the effervescent liquid is retained for at least about 6 hours, wherein the effervescent liquid is stored in the opened container under refrigeration.

11. An effervescent maintenance device, comprising a metallic shaft portion and an arm portion.

12. The effervescent maintenance device of claim 11, wherein the metallic shaft portion comprises silver, sterling silver, gold, platinum, zinc, copper, nickel, iron, aluminum, molybdenum, brass, titanium, steel, stainless steel, or combinations thereof.

13. The effervescent maintenance device of claim 11, wherein the arm portion comprises silver, sterling silver, gold, platinum, zinc, copper, nickel, iron, aluminum, molybdenum, brass, titanium, steel, stainless steel, gem stones, ceramic, glass, porcelain, wood, polymers, or combinations thereof.

14. The effervescent maintenance device of claim 11, wherein the effervescent maintenance device is a solid article or at least partially hollow article.

15. The effervescent maintenance device of claim 11, wherein the metallic shaft portion comprises a diameter of about 0.2 mm to about 100 mm.

16. The effervescent maintenance device of claim 11, wherein the arm portion is of a shape which prevents the effervescent maintenance device from completely entering an opened container.

17. The effervescent maintenance device of claim 11, wherein the effervescent maintenance device is shaped to resemble at least a portion of a botanical plant.

18. The effervescent maintenance device of claim 11, wherein the effervescent maintenance device, when applied, does not touch an effervescent liquid within an opened container.
